(19) United States
(12) Patent Application Publication
(10) Pub. No.: US 2023/0155952 A1
(43) Pub. Date: May 18, 2023

(54) USER DATA PROCESSING DEVICE, NETWORK INTERFACE, AND METHOD

(71) Applicant: NEC Corporation, Minato-ku, Tokyo (JP)

(72) Inventors: Satoshi ISHIKURA, Tokyo (JP); Atsushi SHIROYAMA, Tokyo (JP); Naohiro NOJI, Tokyo (JP)

(73) Assignee: NEC Corporation, Minato-ku, Tokyo (JP)

(21) Appl. No.: 17/917,291

(22) PCT Filed: Apr. 16, 2021
(86) PCT No.: PCT/JP2021/015680

§ 371 Date: Oct. 6, 2022

(30) Foreign Application Priority Data
Apr. 16, 2020 (JP) 2020-073275

(51) Int. Cl. H04L 47/62; H04L 49/00; H04L 47/2408

(52) U.S. Cl. CPC H04L 47/6215; H04L 49/70; H04L 47/2408

(57) ABSTRACT

An identification unit analyzes a received packet and identifies a network slice to which the received packet belongs and a class in QoS. A group of queues includes a plurality of queue groups associated with the plurality of network slices. Each queue group includes a plurality of queues associated with a plurality of classes in the QoS. A distribution unit distributes the received packet to a queue according to an analysis result of the received packet. Each data transfer unit acquires the received packet from the queue associated with each class of the associated queue group, and performs packet transfer processing according to the QoS on the acquired received packet.

### TECHNICAL FIELD

The present disclosure relates to a device and a method for user data processing, a network interface and a method thereof, and a computer-readable medium.

### BACKGROUND ART

The 3rd Generation Partnership Project (3GPP) standardizes 5th generation (5G). A 5G system includes a 5G access network (AN), a 5G core network (CN), and a user equipment (UE), as described in Non Patent Literature 1.

As typical use scenarios in 5G, communications such as massive Internet of things (mIOT), enhanced mobile broadband (eMBB), and ultra-reliable low latency communications (URLLC) are discussed. These communications differ from one another in traffic characteristics, and it is difficult to simultaneously satisfy traffic requirements in all of the communications. For example, in the eMBB requiring a large capacity, packet transfer by bulk processing is optimal. However, in bulk processing, jitter is liable to fluctuate. Therefore, it is difficult to satisfy low delay and high quality required for the URLLC in packet transfer by bulk processing. For such different traffic requirements, 5G discusses separate implementation of communications in a form of network slices.

In a 5G system, network slices with different traffic requirements are separated as network slice instances (NSIs). Further, a particular portion of an NSI (e.g., an access network, a core network, etc.) is defined as a network slice sub-nets instance (NSSI). In particular, NSSIs of a core network are not shared with different NSIs, but are deployed individually.

A network slice of a core network constitutes a network function (NF) of the core network, based on single-network slice selection assistance information (S-NSSAI) to be exchanged among a UE, an, and a CN. A configuration of the NF depends on an operator and a vendor. However, in any configuration, a session management function (SMF) and a user plane function (UPF) are NFs deployed for each network slice.

The UPF is responsible for user-plane (U-Plane) control (user packet control). The UPF is individually deployed by a control-plane (C-Plane) such as an access and mobility management function (AMF) or a network slice selection function (NSSF) that has received the S-NSSAI, and connects with an access network. By individually deploying the UPF, quality of service (QoS) of a user packet is achieved in each network slice.

### CITATION LIST

### Non Patent Literature

[Non Patent Literature] 3GPP TS 23.501 V16.3.0, “System architecture for the 5G System (5GS)”, 2019/12

### SUMMARY OF INVENTION

### Technical Problem

As described above, the UPF is deployed for each network slice. In such a case, loss is generated by dividing hardware/software resources such as a central processing unit (CPU), a power supply capacity, and a physical space, and a management operation cost increases. In order to suppress such a cost, it is conceivable to accommodate U-Plane communication of a plurality of network slices in one UPF. In this case, there is a problem of how to achieve QoS in each network slice.

In view of the above-described circumstances, an object of the present disclosure is to provide a device and a method for user data processing, a network interface and a method thereof, and a computer-readable medium, that are able to efficiently perform QoS control in each network slice while enabling one device to accommodate communication of a plurality of network slices.

### Solution to Problem

In order to achieve the above-described object, the present disclosure provides, as a first aspect, a user data processing device. The user data processing device is provided with: a plurality of data transfer means associated with a plurality of network slices, each of which performs packet transfer processing according to QoS in the associated network slice; an identification means for analyzing a received packet received via a physical port and identifying a network slice to which the received packet belongs and a class in the QoS; and a distribution means for distributing, according to the analysis result of the received packet, the received packet to a group of queues including a plurality of queue groups associated with the plurality of network slices, the queue groups each including a plurality of queues associated with a plurality of classes in the QoS. In the user data processing device, each of the plurality of data transfer means acquires the received packet from a queue associated with each class of the associated queue group, and performs packet transfer processing according to the QoS on the acquired received packet.

The present disclosure provides, as a second aspect, a network interface. The network interface is provided with: an identification means for analyzing a received packet received via a physical port and identifying a network slice to which the received packet belongs and a class in QoS; and a distribution means for distributing, according to the analysis result of the received packet, the received packet to a group of queues including a plurality of queue groups associated with a plurality of network slices, the queue groups each including a plurality of queues associated with a plurality of classes in the QoS.

The present disclosure provides, as a third aspect, a user data processing method. The user data processing method includes: analyzing a received packet received via a physical port, and identifying a network slice to which the received packet belongs and a class in QoS; distributing, according to the analysis result of the received packet, the received packet to a group of queues including a plurality of queue groups associated with a plurality of network slices, the queue groups each including a plurality of queues associated with a plurality of classes in the QoS; and acquiring the received packet from a queue associated with each class of an associated queue group in each network slice, and performing packet transfer processing according to the QoS on the acquired received packet.

The present disclosure provides, as a fourth aspect, a method of a network interface. The method of a network interface includes: analyzing a received packet received via a physical port, and identifying a network slice to which the received packet belongs, and a class in quality of service (QoS); and distributing, according to the analysis result of the received packet, the received packet to a group of queues including a plurality of queue groups associated with a plurality of network slices, the queue groups each including a plurality of queues associated with a plurality of classes in the QoS.

The present disclosure provides, as a fifth aspect, a computer-readable medium. The computer-readable medium stores a program for causing a network interface to execute processing of: analyzing a received packet received via a physical port, and identifying a network slice to which the received packet belongs and a class in quality of service (QoS); and distributing, according to the analysis result of the received packet, the received packet to a group of queues including a plurality of queue groups associated with a plurality of network slices, the queue groups each including a plurality of queues associated with a plurality of classes in the QoS.

### Advantageous Effects of Invention

A device and a method for user data processing, a network interface and a method thereof, and a computer-readable medium according to the present disclosure are able to efficiently perform QoS control in each network slice while enabling one device to accommodate communication of a plurality of network slices.

### BRIEF DESCRIPTION OF DRAWINGS

FIG. 1 is a block diagram illustrating a schematic configuration of a user data processing device according to the present disclosure;

FIG. 2 is a block diagram illustrating a network system including a user data processing device according to a first example embodiment of the present disclosure;

FIG. 3 is a block diagram illustrating a configuration example of a UPF according to the present example embodiment;

FIG. 4 is a diagram illustrating a configuration of a GTP-U packet;

FIG. 5 is a diagram illustrating a configuration of an IP packet;

FIG. 6 is a diagram illustrating one example of a table used for identification of a network slice;

FIG. 7 is a diagram illustrating another example of a table used for identification of a network slice;

FIG. 8 is a flowchart illustrating an operation procedure in the UPF; and

FIG. 9 is a block diagram illustrating a UPF according to a second example embodiment of the present disclosure.

### EXAMPLE EMBODIMENT

Prior to the description of the present disclosure, matters discussed by the present inventors will be described. As described above, if the UPFs are deployed individually for each network slice, QoS of user packet closed for each network slice can be achieved. In the related art, it is not assumed that QoS of a plurality of network slices is achieved in one UPF. If a UPF deployed on one physical server receives user packets of different network slices in a single network interface card (NIC), generally the NIC cannot identify the network slice. Therefore, the UPF applies the same QoS processing to all packets. In this case, there is a problem that different QoS cannot be achieved for each network slice.

A use case of the network slice is provided with a 5G QoS identifier (5QI) (see Non Patent Literature 1). The Internet Engineering Task Force (IETF) discusses mapping of 5QI with differentiated services code point (DSCP) values of Internet protocol (IP) headers. For example, the DSCP value included in the layer 3 (L3) IP header of the user packet is used as one of the values representing QoS. For example, it is assumed that the DSCP value of a packet of a network slice A is “EF” indicating the highest priority processing packet for emergency, and the DSCP value of a packet of another network slice B is also “EF”. In this case, since the priorities of the two packets are the same, it is not possible to guarantee which one is processed first by the UPF.

Further, as a configuration for accommodating communication of a plurality of network slices in one UPF, a configuration is conceivable in which a physical server on which an NIC associated with single root I/O virtualization (SR-IOV) is mounted is used and QoS of a plurality of network slices is achieved in the physical server. In the physical server, a plurality of virtual servers each having a transfer function necessary for each of a plurality of network slices are arranged. The NIC uses SR-IOV technology to arrange a plurality of virtual ports under one physical port. Each virtual port is associated with each virtual server. The NIC routes the packet received at the physical port, based on a virtual local area network (LAN) (VLAN) value and an IP address value of the interface of the virtual server, and transfers the packet to the virtual port of the virtual server. In such manner, QoS in each network slice can be achieved.

However, in the above configuration, a value related to the QoS of the packet can only be identified after the packet reaches a kernel of the virtual server. Therefore, it is impossible to achieve QoS closed for each network slice in an intermediate section from the reception of a packet to the virtual server. The packet transfer using the SR-IOV technique only routes packets based on the VLAN value and the IP address value of the interface of the virtual server. In this SR-IOV section, specific information of the L3 IP header and general packet radio service (GPRS) tunneling protocol for user plane (GTP-U) extension information and the like are not referred to. That is, in the SR-IOV section, there is a problem that the value used to identify the network slice and control the QoS are not referred to.

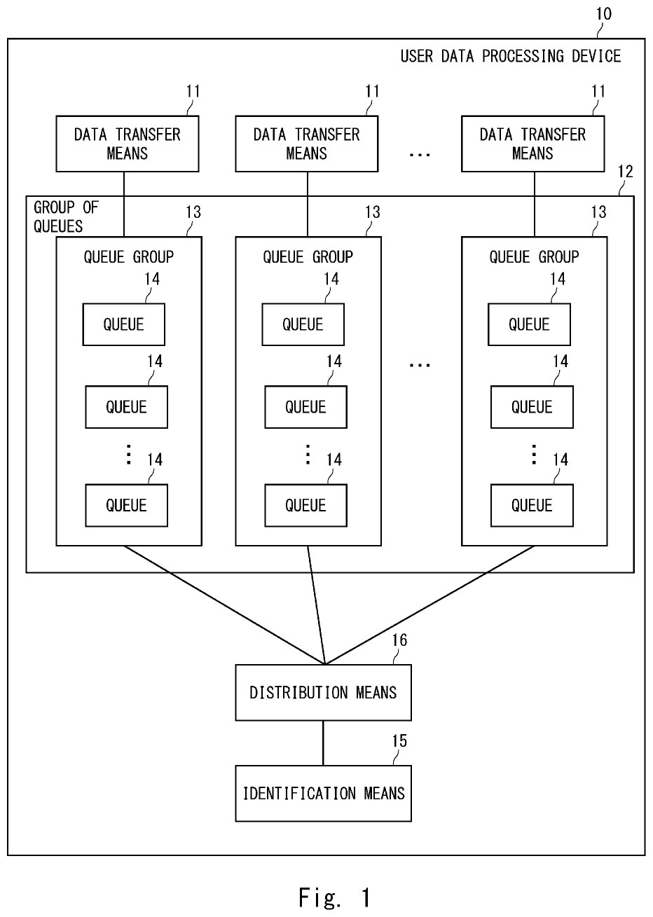

Part of an object of the present disclosure is to provide a user data processing device, a network interface, and a method capable of solving the above-mentioned problems. FIG. 1 illustrates a schematic configuration of a user data processing device according to the present disclosure. The user data processing device 10 includes a plurality of data transfer means 11, a group of queues 12, an identification means 15, and a distribution means 16.

The plurality of data transfer means 11 are associated with a plurality of network slices. Each data transfer means 11 performs packet transfer processing according to QoS in an associated network slice. The identification means 15 receives the received packet via a physical port. The identification means 15 analyzes the received packet and identifies the network slice to which the received packet belongs and the class in QoS.

The group of queues 12 includes a plurality of queue groups 13 associated with a plurality of network slices. Each queue group 13 includes a plurality of queues 14 associated with a plurality of classes in the QoS. The distribution means 16 distributes, according to the identification result of the received packet by the identification means 15, the received packets to the queues in the group of queues 12. Each data transfer means 11 acquires a received packet from the queue 14 associated with each class of the associated queue group 13. Each data transfer means 11 performs packet transfer processing according to the QoS on the acquired received packet.

In the present disclosure, the identification means 15 identifies a network slice and a class in the QoS, based on the analysis result of the received packet. The distribution means 16 determines to which queue group 13 of the plurality of queue groups 13 the packet is to be distributed, according to the identified network slice. Further, the distribution means 16 distributes the received packets to the plurality of queues 14 of the queue group 13 according to the identified class. Each data transfer means 11 acquires a received packet from the queue 14 of the associated queue group 13, and performs packet transfer processing according to the QoS. In this manner, the user data processing device 10 is able to efficiently perform QoS control in each network slice while enabling one device to accommodate communication of a plurality of network slices.

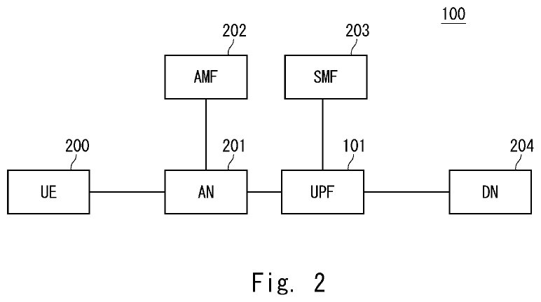

Hereinafter, example embodiments of the present disclosure will be described in detail. FIG. 2 illustrates a network system including a user data processing device according to a first example embodiment of the present disclosure. A network system 100 includes a user data processing device (UPF) 101, a UE 200, an 201, an AMF 202, an SMF 203, and a data network (DN) 204. The UPF 101 corresponds to the user data processing device 10 in FIG. 1.

The UE 200 includes user equipment such as mobile phones, smart phones, tablets, personal computers (PCs), and IoT devices. A plurality of applications in communication with DN 204 may run on the UE 200. The AN 201 includes a base station and the like, and connects the UE 200 and a 5G core network. The AMF 202 performs mobility management. The AMF 202 performs terminal-level processing, for example, subscriber authentication and terminal location management.

The UPF 101 forms a part of the 5G core network. The UPF 101 performs user data communication between the DN 204, which is an external network such as the Internet, and the UE 200. The SMF 203 performs session management. The SMF 203 and the UPF 101 establish a session for the DN 204 for each network slice. Multiple applications running on the UE 200 connect to network slices that meet their respective traffic requirements.

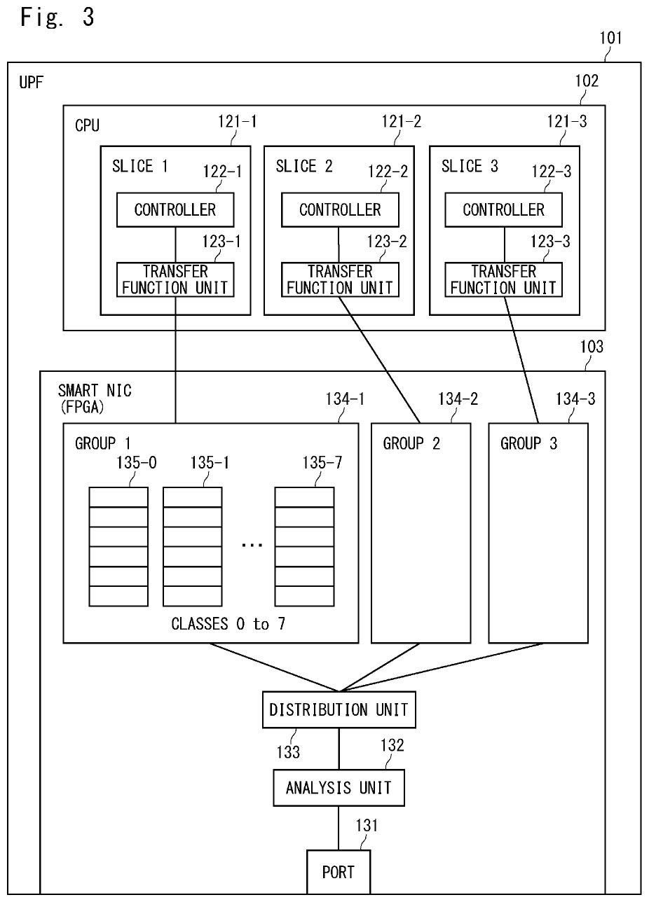

FIG. 3 illustrates a configuration example of the UPF 101 according to the present example embodiment. The UPF 101 includes a CPU 102 and a network interface (smart NIC) 103. The CPU 102 has a UPF function unit associated with a plurality of network slices. The UPF 101 is configured as, for example, a physical server on which the smart NIC 103 is mounted. In the UPF 101, the functions of the plurality of UPF function units are achieved using, for example, server virtual technology.

In the example of FIG. 3, the CPU 102 has three UPF function units 121-1 to 121-3 associated with three network slices. The UPF function unit 121-1 is associated with a network slice 1, the UPF function unit 121-2 is associated with a network slice 2, and the UPF function unit 121-3 is associated with a network slice 3. For example, it is assumed that the UPF function unit 121-1 is a UPF function unit associated with URLLC, the UPF function unit 121-2 is a UPF function unit associated with eMBB, and the UPF function unit 121-3 is a UPF function unit associated with mIoT. The number of network slices and UPF function units is not particularly limited to three.

The UPF function unit 121-1 includes a controller 122-1 and a transfer function unit 123-1. The UPF function unit 121-2 includes a controller 122-2 and a transfer function unit 123-2. The UPF function unit 121-3 includes a controller 122-3 and a transfer function unit 123-3. Note that, the UPF function units 121-1 to 121-3, the controllers 122-1 to 122-3, and the transfer function units 123-1 to 123-3 may also be referred to as a UPF function unit 121, a controller 122, and a transfer function unit 123 when distinction is not necessary.

The controller 122 controls the transfer function unit 123, based on a signal transmitted from the SMF 203 (see FIG. 2). The transfer function unit 123 performs packet transfer processing according to the QoS in the associated network slice. The transfer function unit 123 includes a reception unit (Rx) that acquires a packet from the smart NIC 103, a function unit that determines a packet transfer destination and the like, and a transmission unit (Tx) that transmits the packet to the AN 201 or the DN 204 through the smart NIC 103. Each of the transfer function unit 123 provides a packet transfer function that satisfies the traffic requirements required for the associated network slice. The transfer function unit 123 corresponds to the data transfer means 11 in FIG. 1.

The smart NIC 103 has a port 131, an analysis unit 132, a distribution unit 133, and a plurality of queue groups 134-1 to 134-3. The smart NIC 103 is configured using hardware including a programmable logic device (PLD) such as, for example, a field programmable gate array (FPGA). The smart NIC 103 may be configured using hardware including other devices, for example, a semiconductor device including a processor and a memory, instead of or in addition to the PLD. In this case, at least some of the functions of the analysis unit 132 and the distribution unit 133 may be implemented by the processor operating according to a program read from the memory.

The port 131 receives packets from the AN 201 and the DN 204. Further, the port 131 outputs packets to the AN 201 and the DN 204. The port 131 outputs the packet that has been received (received packet) to the analysis unit 132. The analysis unit 132 parses the received packet, and identifies the network slice to which the received packet belongs and the class in the QoS. For example, the analysis unit 132 identifies a network slice by referring to a specific range of the received packets. The analysis unit 132 identifies the class in the QoS, based on the class of service (CoS) value included in the layer 2 (L2) Ethernet (registered trademark) frame of the received packet. The analysis unit 132 corresponds to the identification means 15 in FIG. 1.

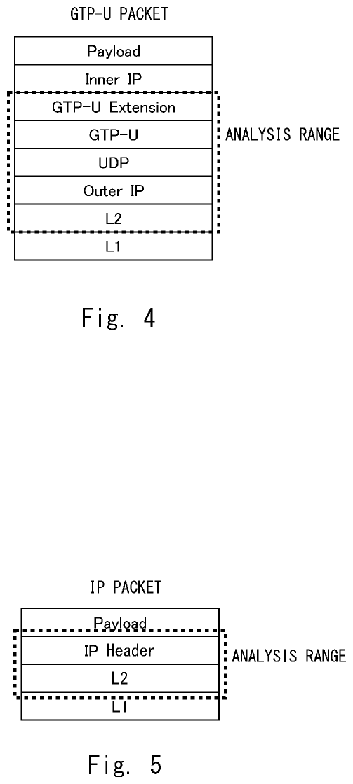

FIG. 4 illustrates a configuration of a GTP-U packet. The GTP-U packet has a payload, an inner IP, a GTP-U Extension, a GTP-U, a user datagram protocol (UDP), an outer IP, L2, and layer 1 (L1). When the received packet is a GTP-U packet, the analysis unit 132 is able to identify the network slice by referring to a range from the L2 Ethernet frame to the GTP-U Extension as a specific range.

FIG. 5 illustrates a configuration of an IP packet. The IP packet has a payload, L2, and L1. When the received packet is an IP packet, the analysis unit 132 is able to identify the network slice by referring to a range from the L2 Ethernet frame to the L3 IP header as a specific range.

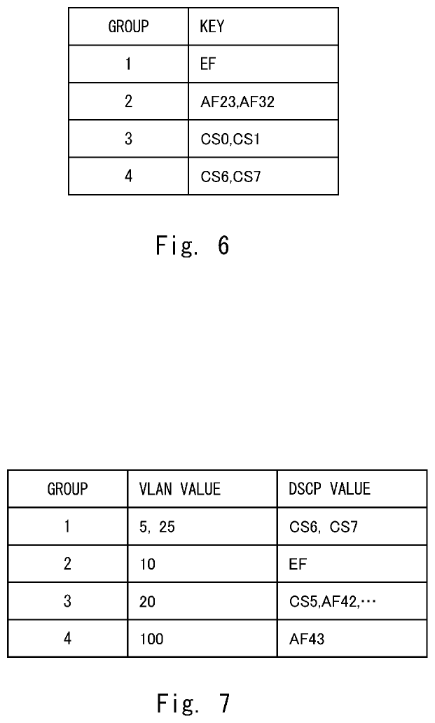

FIG. 6 illustrates one example of a table used to identify a network slice. The table stores the number of the group associated with the network slice and a distribution key in association with each other. The analysis unit 132 refers to the table, and when the received packet includes a value or a type designated as the distribution key, identifies a network slice associated with the distribution key as the network slice to which the received packet belongs. For example, when the DSCP value included in the L3 IP header in the received packet is “EF”, the analysis unit 132 identifies the received packet as a packet of the network slice 1.

FIG. 7 illustrates another example of a table used to identify a network slice. In this example, a VLAN value (VLAN identifier (ID)) included in the L2 Ethernet frame and the DSCP value included in the L3 IP header are designated as the distribution key. In this case, the analysis unit 132 identifies the network slice, based on the combination of the VLAN value and the DSCP value. For example, when VLAN ID=5 and DSCP=CS6 in the received packet, the analysis unit 132 identifies the received packet as a packet of the network slice 1. As in this example, the distribution key may include values or types of a plurality of fields in the received packet.

Returning to FIG. 3, in the smart NIC 103, the plurality of queue groups 134-1 to 134-3 are associated with a plurality of network slices. The queue group 134-1 is a queue group of group 1 associated with the network slice 1. The queue group 134-1 includes a plurality of queues 135-0 to 135-7. The queues 135-0 to 135-7 illustrated in FIG. 3 are associated with, for example, classes 0 to 7 in the QoS control of the network slice 1. Note that, in the following description, the queue groups 134-1 to 134-3 and the queues 135-0 to 135-7 may also be referred to as a queue group 134 and a queue 135 when distinction is not necessary.

The queue group 134-2 is a queue group of group 2 associated with the network slice 2. The queue group 134-3 is a queue group of group 3 associated with the network slice 3. Although not illustrated in FIG. 3, the queue groups 134-2 and 134-3 similarly have queues 135 associated with a plurality of classes in the control in the QoS of the associated network slice. In each queue group 134, the length of each queue may be variable. The queue group 134 corresponds to the queue group 13 in FIG. 1. The queue 135 corresponds to the queue 14 in FIG. 1.

The distribution unit 133 distributes, according to the analysis result of the received packets in the analysis unit 132, the received packets to the queues 135 in the plurality of queue groups 134. The distribution unit 133 stores, for example, the received packet in the queue 135 associated with the identified class, the queue 135 being included in the queue group 134 associated with the identified network slice. For example, it is assumed that the network slice to which the received packet belongs is identified as the network slice 1, and the value of CoS included in the L2 Ethernet frame is “1”. In this case, the distribution unit 133 stores the received packet in the queue 135-1 associated with the class 1 in the queue group 134-1. The distribution unit 133 corresponds to the distribution means 16 in FIG. 1.

The transfer function unit 123 associated with each network slice acquires a received packet from a queue associated with each class of the associated queue group 134. For example, the transfer function unit 123-1 associated with the network slice 1 acquires the received packet from the queues 135-0 to 135-7 included in the queue group 134-1, according to a predetermined rule. The transfer function unit 123 performs packet transfer processing according to QoS on the acquired received packet. The transfer function unit 123 transmits the packet to the AN 201 or the DN 204 being the transfer destination through the smart NIC 103.

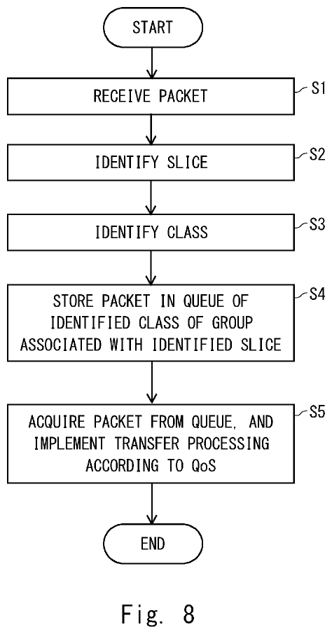

Next, an operation procedure will be described. FIG. 8 illustrates an operation procedure (a user data processing method) of the UPF 101. The port 131 receives a received packet from the AN 201 or the DN 204 (step S1). The analysis unit 132 parses the received packet. The analysis unit 132 identifies a network slice to which the received packet belongs (step S2). In step S2, the analysis unit 132 identifies the network slice using, for example, the table illustrated in FIG. 6 or the table illustrated in FIG. 7. The analysis unit 132 identifies the service class of the received packet (step S3).

The distribution unit 133 stores the received packet in a queue 135 associated with the identified class in a queue group 134 associated with the identified network slice (step S4). For example, when the network slice is “1” and the class is “0”, the distribution unit 133 stores the received packet in the queue 135-0 of the queue group 134-1. The processing of steps S1 to S4 corresponds to the method in the network interface implemented in the smart NIC

The transfer function unit 123 of the UPF function unit 121 associated with each network slice acquires the received packet from the queue 135 of the associated queue group 134. The transfer function unit 123 performs packet transfer processing according to the QoS on the received packet (step S5). In step S5, the transfer function unit 123-1 associated with the network slice 1 acquires the received packet from the queue 135 of the queue group 134-1. The transfer function unit 123-2 associated with the network slice 2 acquires the received packet from the queue 135 of the queue group 134-2. The transfer function unit 123-3 associated with the network slice 3 acquires the received packet from the queue 135 of the queue group 134-3. In such manner, QoS control can be performed independently in each network slice.

In the present example embodiment, the analysis unit 132 identifies the network slice to which the received packet belongs and the class in the QoS.

The distribution unit 133 distributes the received packet to the queue 135 associated with the identified class in the queue group 134 associated with the identified network slice. In each network slice, the transfer function unit 123 acquires a received packet from the queue 135 of the associated queue group 134, and performs packet transfer processing according to the QoS. In such manner, one UPF is able to accommodate U-Plane communication that achieves the QoS for each network slice.

In the present example embodiment, the smart NIC 103 is used to distribute received packets to queues 135 associated with each network slice and classes in the QoS. Assume that the classes in the QoS are not identified in the NIC and the received packets of all classes are stored in a single queue in order of arrival for each network slice. In this case, in a certain network slice, a queue may be filled with a received packet of a low-priority class, and it may take a long time until a received packet of a high-priority class received later is acquired by the transfer function unit 123. In the present example embodiment, before the received packet reaches the transfer function unit 123, the received packet is able to be separated into each network slice and class in the QoS. Therefore, even when the received packet of the low-priority class is stored in the queue 135, the transfer function unit 123 is able to acquire the received packet of the high-priority class, and execute the packet transfer processing preferentially with respect to the received packet of the high-priority class.

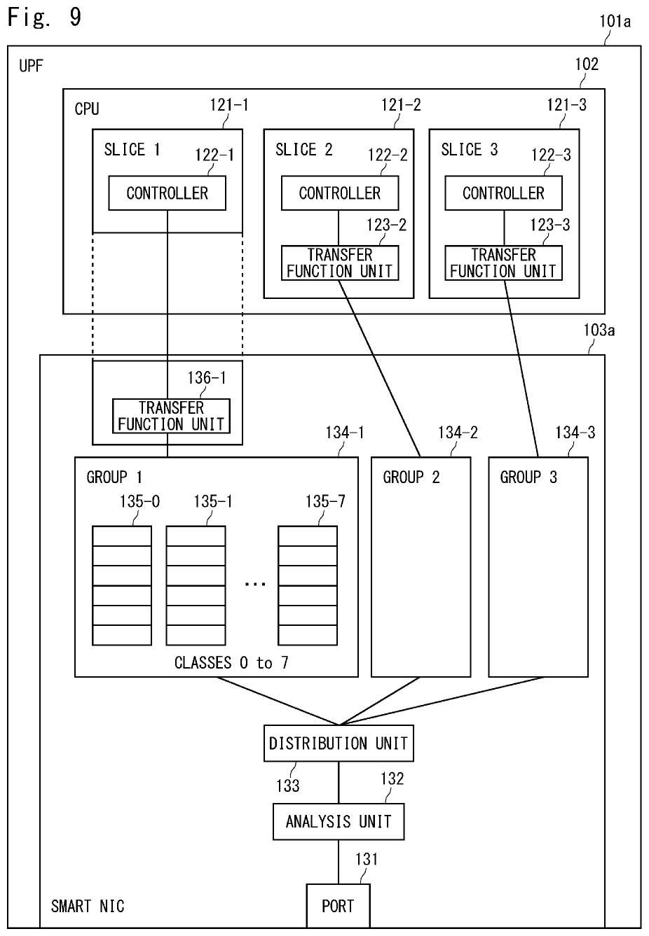

Next, a second example embodiment of the present disclosure will be described. FIG. 9 illustrates a UPF according to a second example embodiment of the present disclosure. A UPF 101a according to the present example embodiment includes a CPU 102a and a smart NIC 103a. In the present example embodiment, some of the plurality of transfer function units are arranged in the smart NIC 103a, and the remaining transfer function units are arranged in a physical server (CPU 102a). The transfer function units arranged in the smart NIC 103a may include a transfer function unit associated with a network slice that requires the lowest delay in traffic requirements. Other configurations may be similar to the configuration of the first example embodiment.

In the CPU 102a, for example, a UPF function unit 121-1a of a network slice 1 associated with URLLC has a configuration in which the transfer function unit 123-1 is omitted from the configuration of the UPF function unit 121-1 according to the first example embodiment illustrated in FIG. 3. The smart NIC 103a has a transfer function unit 136-1 in addition to the configuration of the smart NIC 103 according to the first example embodiment illustrated in FIG. 3. The transfer function unit 136-1 acquires a received packet from the queue 135 in the queue group 134-1, and performs packet transfer processing. The packet transfer processing in the network slice 1 may be the same as the packet transfer processing performed by the transfer function unit 123-1 according to the first example embodiment, except that the packet transfer processing is performed in the smart NIC 103a.

In the present example embodiment, a part of the transfer function unit is arranged in the smart NIC 103a. In such case, for a particular network slice, the transfer of a packet may be performed in the smart NIC 103a. Therefore, the delay of the packet transfer can be reduced as compared with the case where the packet transfer processing is performed in the CPU 102a. Other effects are similar to the effects according to the first example embodiment.

In each of the example embodiments described above, the program for implementing each function in the smart NIC 103 may be stored using various types of non-transitory computer-readable media and provided to the smart NIC (e.g., FPGA). Non-transitory computer-readable media include various types of tangible storage media. Examples of non-transitory computer-readable media include magnetic recording media, magneto-optical recording media, optical disk media, and semiconductor memories. The magnetic recording media include, for example, a magnetic recording medium such as a flexible disk, a magnetic tape, or a hard disk. The magneto-optical recording media include, for example, a magneto-optical recording medium such as a magneto-optical disk. The optical disc media include, for example, a disc medium such as a compact disc (CD) or a digital versatile disk (DVD). The semiconductor memories include a semiconductor memory such as a mask read-only memory (ROM), a programmable ROM (PROM), an erasable PROM (EPROM), a flash ROM, or a random access memory (RAM). Further, the program may also be provided to the smart NIC using various types of transitory computer-readable media. Examples of transitory computer-readable media include electrical signals, optical signals, and electromagnetic waves. The transitory computer-readable medium may provide the program to the smart NIC via wired or wireless communication paths, such as electrical wires and optical fibers.

While the example embodiments of the present disclosure have been described in detail above, the present disclosure is not limited to the example embodiments described above. The present disclosure may include changes and modifications to the example embodiments described above without departing from the spirit of the present disclosure.

For example, some or all of the above example embodiments may also be described as the following supplementary notes, but are not limited to the following.

### [Supplementary Note 1]

A user data processing device comprising:

a plurality of data transfer means, being associated with a plurality of network slices, each for performing packet transfer processing according to quality of service (QoS) in an associated network slice;

identification means for analyzing a received packet received via a physical port and identifying a network slice to which the received packet belongs and a class in the QoS; and

distribution means for distributing, according to an analysis result of the received packet, the received packet to a group of queues including a plurality of queue groups associated with the plurality of network slices, the queue groups each including a plurality of queues associated with a plurality of classes in the QoS,

wherein each of the plurality of data transfer means acquires the received packet from a queue associated with each class of an associated queue group, and performs packet transfer processing according to the QoS on the acquired received packet.

### [Supplementary Note 2]

The user data processing device according to Supplementary note 1, wherein the identification means refers to a specific range of the received packet and identifies the network slice.

### [Supplementary Note 3]

The user data processing device according to Supplementary note 2, wherein the identification means refers to a range from a layer 2 (L2) Ethernet frame to a general packet radio service (GPRS) tunneling protocol for user plane (GTP-U) extension as the specific range when the received packet is a GTP-U packet.

### [Supplementary Note 4]

The user data processing device according to Supplementary note 2 or 3, wherein the identification means refers to a range from an L2 Ethernet frame to a layer 3 (L3) IP header as the specific range when the received packet is an Internet protocol (IP) packet.

[Supplementary note 5]

The user data processing device according to any one of Supplementary note s 1 to 4, wherein the identification means refers to a table storing the network slice and a distribution key in association with each other, and identifies a network slice associated with the distribution key as a network slice to which the received packet belongs when the received packet includes a value or a type designated as the distribution key.

### [Supplementary Note 6]

The user data processing device according to Supplementary note 5, wherein the distribution key includes values or types of a plurality of fields in the received packet.

### [Supplementary Note 7]

The user data processing device according to any one of Supplementary note s 1 to 6, wherein the identification means and the distribution means are disposed in a network interface mounted on a physical server.

### [Supplementary Note 8]

The user data processing device according to Supplementary note 7, wherein the plurality of data transfer means are disposed in the physical server.

### [Supplementary Note 9]

The user data processing device according to Supplementary note 7, wherein a part of the plurality of data transfer means is disposed in the network interface, and a remainder of the plurality of data transfer means is disposed in the physical server.

### [Supplementary Note 10]

The user data processing device according to Supplementary note 9, wherein data transfer means disposed in the network interface includes data transfer means associated with a network slice that requires a lowest delay in a traffic requirement.

### [Supplementary Note 11]

The user data processing device according to any one of Supplementary note s 1 to 10, wherein the identification means identifies the class, based on a class of service (CoS) value included in the received packet.

### [Supplementary Note 12]

The user data processing device according to any one of Supplementary note s 1 to 11, wherein the distribution means distributes the received packet to a queue associated with the identified class being included in a queue group associated with the identified network slice.

### [Supplementary Note 13]

The user data processing device according to any one of Supplementary note s 1 to 12, wherein, in the queue group, a length of the plurality of queues is variable.

### [Supplementary Note 14]

The user data processing device according to any one of Supplementary note s 1 to 13, wherein each of the plurality of data transfer means provides a packet transfer function satisfying a traffic requirement required for an associated network slice.

### [Supplementary Note 15]

A network interface comprising:

identification means for analyzing a received packet received via a physical port and identifying a network slice to which the received packet belongs and a class in quality of service (QoS); and

distribution means for distributing, according to an analysis result of the received packet, the received packet to a group of queues including a plurality of queue groups associated with a plurality of network slices, the queue groups each including a plurality of queues associated with a plurality of classes in the QoS.

### [Supplementary Note 16]

The network interface according to Supplementary note 15, wherein the identification means refers to a specific range of the received packet and identifies the network slice.

[Supplementary note 17]

The network interface according to Supplementary note 15 or 16, wherein the identification means identifies the class, based on a class of service (CoS) value included in the received packet.

[Supplementary note 18]

The network interface according to any one of Supplementary note s 15 to 17, wherein the distribution means distributes the received packet to a queue associated with the identified class being included in a queue group associated with the identified network slice.

### [Supplementary Note 19]

A user data processing method comprising:

analyzing a received packet received via a physical port, and identifying a network slice to which the received packet belongs and a class in quality of service (QoS);

distributing, according to an analysis result of the received packet, the received packet to a group of queues including a plurality of queue groups associated with a plurality of network slices, the queue groups each including a plurality of queues associated with a plurality of classes in the QoS; and

acquiring the received packet from a queue associated with each class of an associated queue group in each network slice, and performing packet transfer processing according to the QoS on the acquired received packet.

### [Supplementary Note 20]

A method of a network interface, the method comprising:

analyzing a received packet received via a physical port, and identifying a network slice to which the received packet belongs and a class in quality of service (QoS); and

distributing, according to an analysis result of the received packet, the received packet to a group of queues including a plurality of queue groups associated with a plurality of network slices, the queue groups each including a plurality of queues associated with a plurality of classes in the QoS.

### [Supplementary Note 21]

A non-transitory computer-readable medium configured to store a program for causing a network interface to execute processing of:

analyzing a received packet received via a physical port, and identifying a network slice to which the received packet belongs and a class in quality of service (QoS); and

distributing, according to an analysis result of the received packet, the received packet to a group of queues including a plurality of queue groups associated with a plurality of network slices, the queue groups each including a plurality of queues associated with a plurality of classes in the QoS.

This application is based upon and claims the benefit of priority from Japanese Patent Application No. 2020-073275, filed on Apr. 16, 2020, the disclosure of which is incorporated herein in its entirety by reference.

### reference signs list

10 USER DATA PROCESSING DEVICE
11 DATA TRANSFER MEANS
12 GROUP OF QUEUES
13 QUEUE GROUP
14 QUEUE
15 IDENTIFICATION MEANS
16 DISTRIBUTION MEANS
100 NETWORK SYSTEM
101 UPF
102 CPU
103 SMART NIC
121 UPF FUNCTION UNIT
122 CONTROLLER
123 TRANSFER FUNCTION UNIT
131 PORT
132 ANALYSIS UNIT
133 DISTRIBUTION UNIT
134 QUEUE GROUP
135 QUEUE
136 TRANSFER FUNCTION UNIT
200 UE
201 AN
202 AMF
203 SMF
204 DN

What is claimed is:

1. A user data processing device comprising:
at least one memory storing instructions; and
at least one processor configured to execute the instructions to:
analyze a received packet received via a physical port and identify a network slice, from among a plurality of network slices, to which the received packet belongs and a class in quality of service (QoS); and
distribute, according to an analysis result of the received packet, the received packet to a group of queues including a plurality of queue groups associated with the plurality of network slices, the queue groups each including a plurality of queues associated with a plurality of classes in the QoS,
acquire, for each of network slices, the received packet from a queue associated with each class of an queue group, group associated with the network slice, and perform packet transfer processing according to the QoS on the acquired received packet.

2. The user data processing device according to claim 1, wherein the at least one processor is configured to execute the instructions to refer to a specific range of the received packet and identify the network slice.

3. The user data processing device according to claim 2, wherein the at least one processor is configured to execute the instructions to refer to a range from a layer 2 (L2) Ethernet frame to a general packet radio service (GPRS) tunneling protocol for user plane (GTP-U) extension as the specific range when the received packet is a GTP-U packet.

4. The user data processing device according to claim 2, wherein the at least one processor is configured to execute the instructions to refer to a range from an L2 Ethernet frame to a layer 3 (L3) IP header as the specific range when the received packet is an Internet protocol (IP) packet.

5. The user data processing device according to claim 1, wherein the at least one processor is configured to execute the instructions to refer to a table storing the network slice and a distribution key in association with each other, and identify a network slice associated with the distribution key as a network slice to which the received packet belongs when the received packet includes a value or a type designated as the distribution key.

6. The user data processing device according to claim 5, wherein the distribution key includes values or types of a plurality of fields in the received packet.

7. The user data processing device according to claim 1, wherein the identification of the network slice and the class and distribution of the received packet to the group of the queues are performed in a network interface mounted on a physical server.

8. The user data processing device according to claim 7, wherein the packet transfer processing for each of network slices is performed in the physical server.

9. The user data processing device according to claim 7, wherein the packet transfer processing for a part of the plurality of network slices is performed in the network interface, and the packet transfer processing for a remainder of the plurality of network slices is performed in the physical server.

10. The user data processing device according to claim 9, wherein a network slices for which data transfer processing is performed in the network interface includes a network slice that requires a lowest delay in a traffic requirement.

11. The user data processing device according to claim 1, wherein the at least one processor is configured to execute the instructions to identify the class, based on a class of service (CoS) value included in the received packet.

12. The user data processing device according to claim 1, wherein the at least one processor is configured to execute the instructions to distribute the received packet to a queue associated with the identified class being included in a queue group associated with the identified network slice.

13. The user data processing device according to claim 1, wherein, in the queue group, a length of the plurality of queues is variable.

14. The user data processing device according to claim 1, wherein, in the data transfer processing for each network slices, a traffic requirement required for each network slice is satisfied.

15. A network interface comprising:
at least one memory storing instructions; and
at least one processor configured to execute the instructions to:
analyze a received packet received via a physical port and identify a network slice to which the received packet belongs and a class in quality of service (QoS); and
distribute, according to an analysis result of the received packet, the received packet to a group of queues including a plurality of queue groups associated with a plurality of network slices, the queue groups each including a plurality of queues associated with a plurality of classes in the QoS.

16. The network interface according to claim 15, wherein the at least one processor is configured to execute the instructions to refer to a specific range of the received packet and identify the network slice.

17. The network interface according to claim 15, wherein the at least one processor is configured to execute the instructions to identify the class, based on a class of service (CoS) value included in the received packet.

18. The network interface according to claim 15, wherein the at least one processor is configured to execute the instructions to distribute the received packet to a queue associated with the identified class being included in a queue group associated with the identified network slice.

19. A user data processing method comprising:
analyzing a received packet received via a physical port, and identifying a network slice to which the received packet belongs and a class in quality of service (QoS);
distributing, according to an analysis result of the received packet, the received packet to a group of queues including a plurality of queue groups associated with a plurality of network slices, the queue groups each including a plurality of queues associated with a plurality of classes in the QoS; and
acquiring the received packet from a queue associated with each class of an associated queue group in each network slice, and performing packet transfer processing according to the QoS on the acquired received packet.

20-21. (canceled)
